(19) United States
(12) Patent Application Publication
(10) Pub. No.: US 2025/0071194 A1
(43) Pub. Date: Feb. 27, 2025

(54) PLUGGABLE TRANSCEIVER WITH BUILT-IN DETECTION AND MITIGATION OF MALICIOUS NETWORK TRAFFIC

(71) Applicant: Charter Communications Operating, LLC, St. Louis, MO (US)

(72) Inventor: Taylor Harris, Castle Rock, CO (US)

(21) Appl. No.: 18/237,393

(22) Filed: Aug. 23, 2023

(51) Int. Cl. H04L 69/22; H04L 49/90

(52) U.S. Cl. CPC H04L 69/22; H04L 49/9068

(57) ABSTRACT

An apparatus includes a network interface receiver configured to receive a plurality of packets; an electronic circuit statically configured in hardware to extract a header of each received packet, evaluate each extracted header based on an access control ruleset, and, based on the evaluation, pass a first portion of the received packets and discard a second portion of the received packets; and a network interface transmitter configured to transmit the first portion of the received packets.

### FIELD OF THE INVENTION

The present invention relates generally to the electrical, electronic and computer arts, and, more particularly, to network management and network devices.

### BACKGROUND OF THE INVENTION

There is an ongoing concern with regard to detecting and mitigating malicious network traffic, such as network traffic that is part of a Distributed Denial of Service (DDoS) attack. DDoS attacks are a universal threat to all Internet-connected devices. Current techniques include the use of firewalls and/or the use of access control lists (ACLs) on routers. Once detected, the malicious network traffic may be mitigated by blocking the network traffic, forwarding suspected malicious network traffic for further evaluation, and the like. Conventional detection and mitigation techniques often introduce network delays, consume large amounts of resources, and are subject to being overwhelmed when encountering large amounts of network traffic.

Small Form-factor Pluggable (SFP) is a network interface module format used for both telecommunication and data communications applications. On a piece of network hardware, an SFP interface provides a modular slot for a media-specific transceiver, such as for fiber-optics or copper. This allows individual ports to be equipped with different types of transceivers. The media-specific transceivers are known as small form factor pluggable (SFP) devices.

### SUMMARY OF THE INVENTION

Principles of the invention provide a pluggable transceiver with built-in detection and mitigation of malicious network traffic.

In one aspect, an exemplary apparatus includes a network interface receiver configured to receive a plurality of packets; an electronic circuit statically configured in hardware to extract a header of each received packet, evaluate each extracted header based on an access control ruleset, and, based on the evaluation, pass a first portion of the received packets and discard a second portion of the received packets; and a network interface transmitter configured to transmit the first portion of the received packets.

In another aspect, an exemplary assembly is provided for connection to an upstream network; the assembly includes a small form-factor pluggable module such as the apparatus described above, and a protected device coupled to the network interface transmitter.

In still another aspect, an exemplary trusted network is provided for connection to an upstream untrusted network. The trusted network includes a plurality of small form-factor pluggable modules as described, and a plurality of protected devices, within the trusted network, and coupled to the network interface transmitters of the plurality of small form-factor pluggable modules.

In a further aspect, an exemplary method includes the operations of attaching, between a unit of network equipment and an upstream interface towards an untrusted network, a small form factor pluggable device as described; receiving the plurality of packets from the untrusted network; and, with the electronic circuit, passing the first portion of the received packets and discarding the second portion of the received packets.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in hardware, such as with an ASIC or FPGA. Embodiments of the invention can be used, for example, in a network which makes use of (i) one or more non-transitory machine-readable medium(s) that contains one or more programs which when executed implement appropriate functionality; and/or (ii) one or more apparatus(es) including a memory and at least one processor that is coupled to the memory and operative to perform, or facilitate performance of, appropriate functionality (or a system wherein one or more such apparatuses are networked together, optionally with one or more other components).

Aspects of the present invention can provide substantial beneficial technical effects. For example, one or more embodiments of the invention achieve one or more of:
a pluggable, small form factor transceiver with “firewall” functionality;
a hardware-implemented access control ruleset that only requires limited network management support;
detection and mitigation support for the most well-known, malicious network traffic signatures;
improved network performance due to high-performance, hardware-based “firewall” functionality;
reduced network management requirements; and/or
improved performance of network devices by offloading designated “firewall” functionality.

These and other features and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a block diagram of an exemplary embodiment of a system, within which one or more aspects of the invention can be implemented;

FIG. 2 is a functional block diagram illustrating an exemplary hybrid fiber-coaxial (HFC) divisional network configuration, useful within the system of FIG. 1;

FIG. 3 is a functional block diagram illustrating one exemplary HFC cable network head-end configuration, useful within the system of FIG. 1;

FIG. 4 is a functional block diagram illustrating one exemplary local service node configuration useful within the system of FIG. 1;

FIG. 5 is a functional block diagram of a premises network, including an exemplary centralized customer premises equipment (CPE) unit, interfacing with a head end such as that of FIG. 3;

FIG. 6 is a functional block diagram of an exemplary centralized CPE unit, useful within the system of FIG. 1;

FIG. 7 is a block diagram of a computer system useful in connection with one or more aspects of the invention;

FIG. 8 is a functional block diagram illustrating an exemplary FTTH system, which is one exemplary system within which one or more embodiments could be employed;

FIG. 9 is a functional block diagram of an exemplary centralized S-ONU CPE unit interfacing with the system of FIG. 8;

FIG. 10A is an illustration of a conventional small form-factor pluggable (SFP) device according to the prior art;

FIG. 10B is a high-level block diagram of the receive optical sub-assembly (ROSA) and the post-amplifier of the conventional SFP device according to the prior art;

FIG. 11 is a high-level block diagram of an unmanaged and active SFP device and a corresponding network hardware device, in accordance with an example embodiment;

FIG. 12 is a mid-level block diagram of the unmanaged and active SFP device, in accordance with an example embodiment;

FIG. 13 is a block diagram of the unmanaged and active SFP device, in accordance with an example embodiment;

FIG. 14 is a table of example rules for detecting and mitigating malicious network traffic, in accordance with an example embodiment;

FIG. 15 is a flow chart of logic implemented by an unmanaged and active SFP device according to exemplary embodiments;

FIG. 16 is another table of example rules for detecting and mitigating malicious network traffic, in accordance with an example embodiment; and

FIG. 17 is another flow chart of logic implemented by an unmanaged and active SFP device according to exemplary embodiments.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION OF PREFERRED EMBODIMENTS

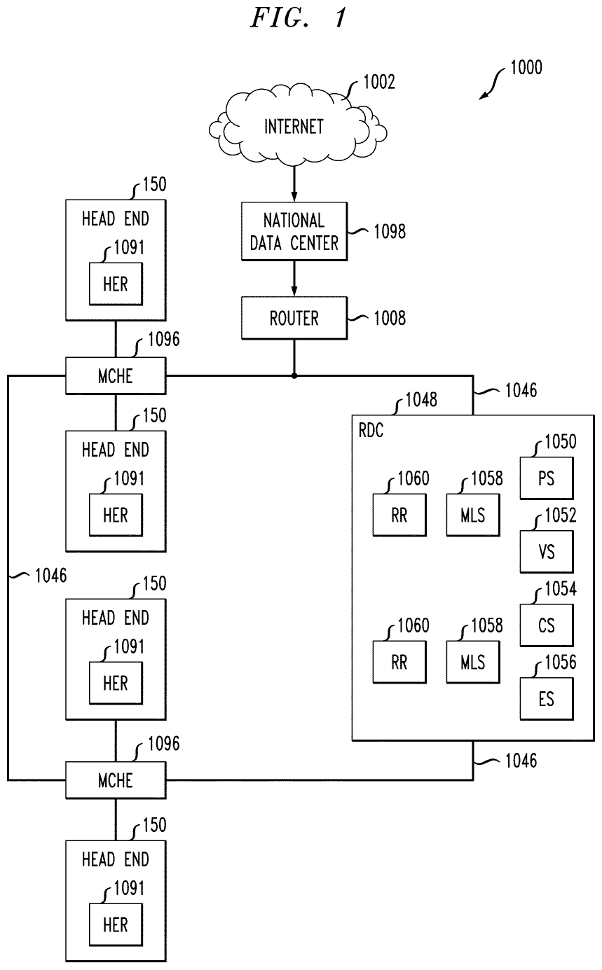

Purely by way of example and not limitation, a description will be provided of a cable multi-service operator (MSO) providing data services as well as entertainment services, as an example environment in which aspects of the invention could be employed, it being understood that aspects of the invention could be employed in many different network environments. FIG. 1 shows an exemplary system 1000, according to an aspect of the invention. System 1000 includes a regional data center (RDC) 1048 coupled to several Market Center Head Ends (MCHEs) 1096; each MCHE 1096 is in turn coupled to one or more divisions, represented by division head ends 150. In a non-limiting example, the MCHEs are coupled to the RDC 1048 via a network of switches and routers. One suitable example of network 1046 is a dense wavelength division multiplex (DWDM) network. The MCHEs can be employed, for example, for large metropolitan area(s). In addition, the MCHE is connected to localized HEs 150 via high-speed routers 1091 (“HER”=head end router) and a suitable network, which could, for example, also utilize DWDM technology. Elements 1048, 1096 on network 1046 may be operated, for example, by or on behalf of a cable MSO, and may be interconnected with a global system of interconnected computer networks that use the standardized Internet Protocol Suite (TCP/IP) (transfer control protocol/Internet protocol), commonly called the Internet 1002; for example, via router 1008. In one or more non-limiting exemplary embodiments, router 1008 is a point-of-presence (“POP”) router; for example, of the kind available from Juniper Networks, Inc., Sunnyvale, California, USA.

Head end routers 1091 are omitted from figures below to avoid clutter, and not all switches, routers, etc. associated with network 1046 are shown, also to avoid clutter.

RDC 1048 may include one or more provisioning servers (PS) 1050, one or more Video Servers (VS) 1052, one or more content servers (CS) 1054, and one or more e-mail servers(ES) 1056. The same may be interconnected to one or more RDC routers (RR) 1060 by one or more multi-layer switches (MLS) 1058. RDC routers 1060 interconnect with network 1046.

A national data center (NDC) 1098 is provided in some instances; for example, between router 1008 and Internet 1002. In one or more embodiments, such an NDC may consolidate at least some functionality from head ends (local and/or market center) and/or regional data centers. For example, such an NDC might include one or more VOD servers; switched digital video (SDV) functionality; gateways to obtain content (e.g., program content) from various sources including cable feeds and/or satellite; and so on.

In some cases, there may be more than one national data center 1098 (e.g., two) to provide redundancy. There can be multiple regional data centers 1048. In some cases, MCHEs could be omitted and the local head ends 150 coupled directly to the RDC 1048.

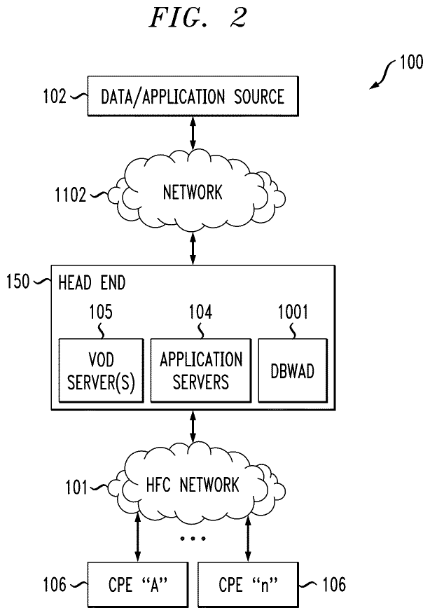

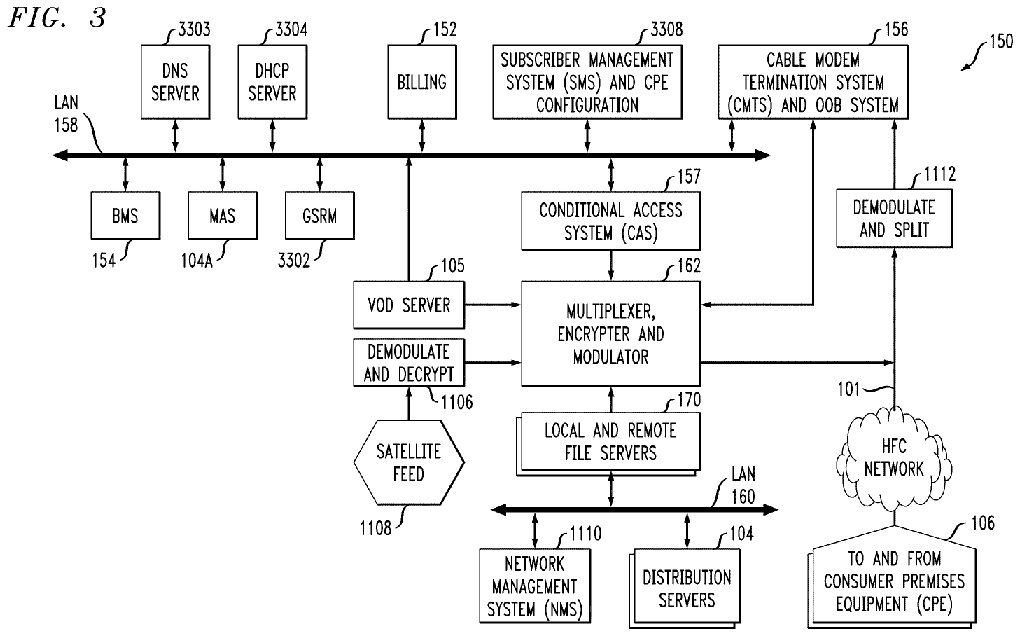

FIG. 2 is a functional block diagram illustrating an exemplary content-based (e.g., hybrid fiber-coaxial (HFC)) divisional network configuration, useful within the system of FIG. 1. See, for example, US Patent Publication 2006/0130107 of Gonder et al., entitled “Method and apparatus for high bandwidth data transmission in content-based networks,” the complete disclosure of which is expressly incorporated by reference herein in its entirety for all purposes. The various components of the network 100 include (i) one or more data and application origination points 102; (ii) one or more application distribution servers 104; (iii) one or more video-on-demand (VOD) servers 105, and (v) consumer premises equipment or customer premises equipment (CPE). The distribution server(s) 104, VOD servers 105 and CPE(s) 106 are connected via a bearer (e.g., HFC) network 101. Servers 104, 105 can be located in head end 150. A simple architecture is shown in FIG. 2 for illustrative brevity, although it will be recognized that comparable architectures with multiple origination points, distribution servers, VOD servers, and/or CPE devices (as well as different network topologies) may be utilized consistent with embodiments of the invention. For example, the head-end architecture of FIG. 3 (described in greater detail below) may be used.

It should be noted that the exemplary CPE 106 is an integrated solution including a cable modem (e.g., DOCSIS) and one or more wireless routers. Other embodiments could employ a two-box solution; i.e., separate cable modem and routers suitably interconnected, which nevertheless, when interconnected, can provide equivalent functionality. Furthermore, FTTH networks can employ Service ONUs (S-ONUs; ONU=optical network unit) as CPE, as discussed elsewhere herein.

The data/application origination point 102 comprises any medium that allows data and/or applications (such as a VOD-based or “Watch TV” application) to be transferred to a distribution server 104, for example, over network 1102. This can include for example a third-party data source, application vendor website, compact disk read-only memory (CD-ROM), external network interface, mass storage device (e.g., Redundant Arrays of Inexpensive Disks (RAID) system), etc. Such transference may be automatic, initiated upon the occurrence of one or more specified events (such as the receipt of a request packet or acknowledgement (ACK)), performed manually, or accomplished in any number of other modes readily recognized by those of ordinary skill, given the teachings herein. For example, in one or more embodiments, network 1102 may correspond to network 1046 of FIG. 1, and the data and application origination point may be, for example, within NDC 1098, RDC 1048, or on the Internet 1002. Head end 150, HFC network 101, and CPEs 106 thus represent the divisions which were represented by division head ends 150 in FIG. 1.

The application distribution server 104 comprises a computer system where such applications can enter the network system. Distribution servers per se are well known in the networking arts, and accordingly not described further herein.

The VOD server 105 comprises a computer system where on-demand content can be received from one or more of the aforementioned data sources 102 and enter the network system. These servers may generate the content locally, or alternatively act as a gateway or intermediary from a distant source.

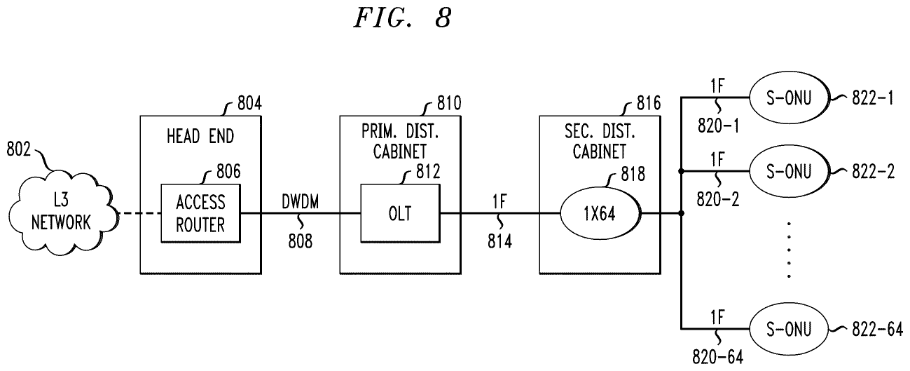

The CPE 106 includes any equipment in the “customers' premises” (or other appropriate locations) that can be accessed by the relevant upstream network components. Non-limiting examples of relevant upstream network components, in the context of the HFC network, include a distribution server 104 or a cable modem termination system 156 (discussed below with regard to FIG. 3). The skilled artisan will be familiar with other relevant upstream network components for other kinds of networks (e.g., FTTH) as discussed herein. Non-limiting examples of CPE are set-top boxes, high-speed cable modems, and Advanced Wireless Gateways (AWGs) for providing high bandwidth Internet access in premises such as homes and businesses. Reference is also made to the discussion of an exemplary FTTH network in connection with FIGS. 8 and 9.

Also included (for example, in head end 150) is a dynamic bandwidth allocation device (DBWAD) 1001 such as a global session resource manager, which is itself a non-limiting example of a session resource manager.

FIG. 3 is a functional block diagram illustrating one exemplary HFC cable network head-end configuration, useful within the system of FIG. 1. As shown in FIG. 3, the head-end architecture 150 comprises typical head-end components and services including billing module 152, subscriber management system (SMS) and CPE configuration management module 3308, cable-modem termination system (CMTS) and out-of-band (OOB) system 156, as well as LAN(s) 158, 160 placing the various components in data communication with one another. In one or more embodiments, there are multiple CMTSs. Each may be coupled to an HER 1091, for example. See, e.g., FIGS. 1 and 2 of co-assigned U.S. Pat. No. 7,792,963 of inventors Gould and Danforth, entitled METHOD TO BLOCK UNAUTHORIZED NETWORK TRAFFIC IN A CABLE DATA NETWORK, the complete disclosure of which is expressly incorporated herein by reference in its entirety for all purposes.

It will be appreciated that while a bar or bus LAN topology is illustrated, any number of other arrangements (e.g., ring, star, etc.) may be used consistent with the invention. It will also be appreciated that the head-end configuration depicted in FIG. 3 is high-level, conceptual architecture and that each multi-service operator (MSO) may have multiple head-ends deployed using custom architectures.

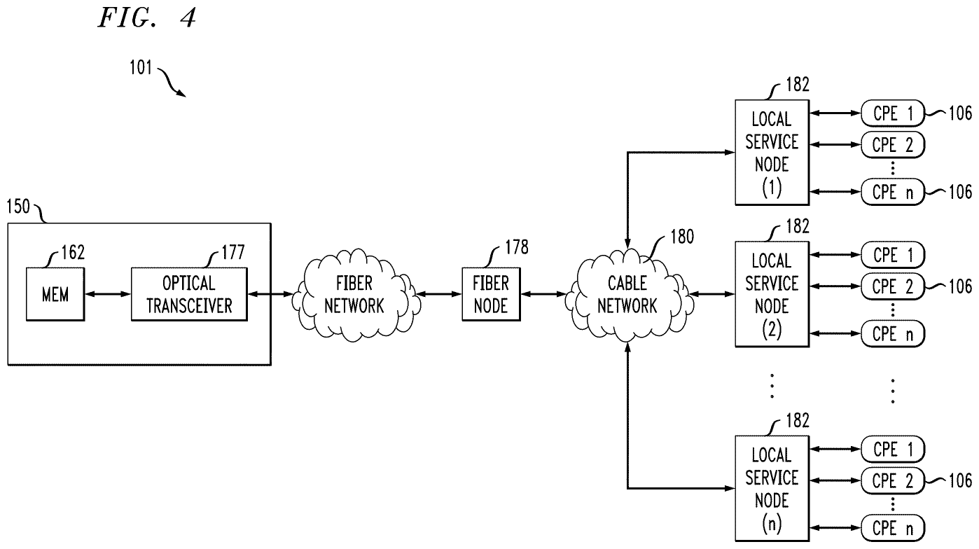

The architecture 150 of FIG. 3 further includes a multiplexer/encrypter/modulator (MEM) 162 coupled to the HFC network 101 adapted to “condition” content for transmission over the network. The distribution servers 104 are coupled to the LAN 160, which provides access to the MEM 162 and network 101 via one or more file servers 170. The VOD servers 105 are coupled to the LAN 158, although other architectures may be employed (such as for example where the VOD servers are associated with a core switching device such as an 802.3z Gigabit Ethernet device; or the VOD servers could be coupled to LAN 160). Since information is typically carried across multiple channels, the head-end should be adapted to acquire the information for the carried channels from various sources. Typically, the channels being delivered from the head-end 150 to the CPE 106 (“downstream”) are multiplexed together in the head-end and sent to neighborhood hubs (refer to description of FIG. 4) via a variety of interposed network components.

Content (e.g., audio, video, etc.) is provided in each downstream (in-band) channel associated with the relevant service group. (Note that in the context of data communications, internet data is passed both downstream and upstream.) To communicate with the head-end or intermediary node (e.g., hub server), the CPE 106 may use the out-of-band (OOB) or DOCSIS® (Data Over Cable Service Interface Specification) channels (registered mark of Cable Television Laboratories, Inc., 400 Centennial Parkway Louisville CO 80027, USA) and associated protocols (e.g., DOCSIS 1.x, 2.0. or 3.0). The OpenCable™ Application Platform (OCAP) 1.0, 2.0, 3.0 (and subsequent) specification (Cable Television laboratories Inc.) provides for exemplary networking protocols both downstream and upstream, although the invention is in no way limited to these approaches. All versions of the DOCSIS and OCAP specifications are expressly incorporated herein by reference in their entireties for all purposes.

Furthermore in this regard, DOCSIS is an international telecommunications standard that permits the addition of high-speed data transfer to an existing cable TV (CATV) system. It is employed by many cable television operators to provide Internet access (cable Internet) over their existing hybrid fiber-coaxial (HFC) infrastructure. HFC systems using DOCSIS to transmit data are one non-limiting exemplary application context for one or more embodiments. However, one or more embodiments are applicable to a variety of different kinds of networks.

It is also worth noting that the use of DOCSIS Provisioning of EPON (Ethernet over Passive Optical Network) or “DPoE” (Specifications available from CableLabs, Louisville, CO, USA) enables the transmission of high-speed data over PONs using DOCSIS back-office systems and processes.

It will also be recognized that multiple servers (broadcast, VOD, or otherwise) can be used, and disposed at two or more different locations if desired, such as being part of different server “farms”. These multiple servers can be used to feed one service group, or alternatively different service groups. In a simple architecture, a single server is used to feed one or more service groups. In another variant, multiple servers located at the same location are used to feed one or more service groups. In yet another variant, multiple servers disposed at different location are used to feed one or more service groups.

In some instances, material may also be obtained from a satellite feed 1108; such material is demodulated and decrypted in block 1106 and fed to block 162. Conditional access system 157 may be provided for access control purposes. Network management system 1110 may provide appropriate management functions. Note also that signals from MEM 162 and upstream signals from network 101 that have been demodulated and split in block 1112 are fed to CMTS and OOB system 156.

Also included in FIG. 3 are a global session resource manager (GSRM) 3302, a Mystro Application Server 104A, and a business management system 154, all of which are coupled to LAN 158. GSRM 3302 is one specific form of a DBWAD 1001 and is a non-limiting example of a session resource manager.

An ISP DNS server could be located in the head-end as shown at 3303, but it can also be located in a variety of other places. One or more Dynamic Host Configuration Protocol (DHCP) server(s) 3304 can also be located where shown or in different locations.

It should be noted that the exemplary architecture in FIG. 3 shows a traditional location for the CMTS 156 in a head end. As will be appreciated by the skilled artisan, CMTS functionality can be moved down closer to the customers or up to a national or regional data center or can be dispersed into one or more locations.

As shown in FIG. 4, the network 101 of FIGS. 2 and 3 comprises a fiber/coax arrangement wherein the output of the MEM 162 of FIG. 3 is transferred to the optical domain (such as via an optical transceiver 177 at the head-end 150 or further downstream). The optical domain signals are then distributed over a fiber network 179 to a fiber node 178, which further distributes the signals over a distribution network 180 (typically coax) to a plurality of local servicing nodes 182. This provides an effective 1-to-N expansion of the network at the local service end. Each node 182 services a number of CPEs 106. Further reference may be had to US Patent Publication 2007/0217436 of Markley et al., entitled “Methods and apparatus for centralized content and data delivery,” the complete disclosure of which is expressly incorporated herein by reference in its entirety for all purposes. In one or more embodiments, the CPE 106 includes a cable modem, such as a DOCSIS-compliant cable modem (DCCM). Please note that the number n of CPE 106 per node 182 may be different than the number n of nodes 182, and that different nodes may service different numbers n of CPE.

Certain additional aspects of video or other content delivery will now be discussed. It should be understood that embodiments of the invention have broad applicability to a variety of different types of networks. Some embodiments relate to TCP/IP network connectivity for delivery of messages and/or content. Again, delivery of data over a video (or other) content network is but one non-limiting example of a context where one or more embodiments could be implemented. US Patent Publication 2003-0056217 of Paul D. Brooks, entitled “Technique for Effectively Providing Program Material in a Cable Television System,” the complete disclosure of which is expressly incorporated herein by reference for all purposes, describes one exemplary broadcast switched digital architecture, although it will be recognized by those of ordinary skill that other approaches and architectures may be substituted. In a cable television system in accordance with the Brooks invention, program materials are made available to subscribers in a neighborhood on an as-needed basis. Specifically, when a subscriber at a set-top terminal selects a program channel to watch, the selection request is transmitted to a head end of the system. In response to such a request, a controller in the head end determines whether the material of the selected program channel has been made available to the neighborhood. If it has been made available, the controller identifies to the set-top terminal the carrier which is carrying the requested program material, and to which the set-top terminal tunes to obtain the requested program material. Otherwise, the controller assigns an unused carrier to carry the requested program material, and informs the set-top terminal of the identity of the newly assigned carrier. The controller also retires those carriers assigned for the program channels which are no longer watched by the subscribers in the neighborhood. Note that reference is made herein, for brevity, to features of the “Brooks invention”—it should be understood that no inference should be drawn that such features are necessarily present in all claimed embodiments of Brooks. The Brooks invention is directed to a technique for utilizing limited network bandwidth to distribute program materials to subscribers in a community access television (CATV) system. In accordance with the Brooks invention, the CATV system makes available to subscribers selected program channels, as opposed to all of the program channels furnished by the system as in prior art. In the Brooks CATV system, the program channels are provided on an as needed basis, and are selected to serve the subscribers in the same neighborhood requesting those channels.

US Patent Publication 2010-0313236 of Albert Straub, entitled “TECHNIQUES FOR UPGRADING SOFTWARE IN A VIDEO CONTENT NETWORK,” the complete disclosure of which is expressly incorporated herein by reference for all purposes, provides additional details on the aforementioned dynamic bandwidth allocation device 1001.

US Patent Publication 2009-0248794 of William L. Helms, entitled “SYSTEM AND METHOD FOR CONTENT SHARING,” the complete disclosure of which is expressly incorporated herein by reference for all purposes, provides additional details on CPE in the form of a converged premises gateway device. Related aspects are also disclosed in US Patent Publication 2007-0217436 of Markley et al, entitled “METHODS AND APPARATUS FOR CENTRALIZED CONTENT AND DATA DELIVERY,” the complete disclosure of which is expressly incorporated herein by reference for all purposes.

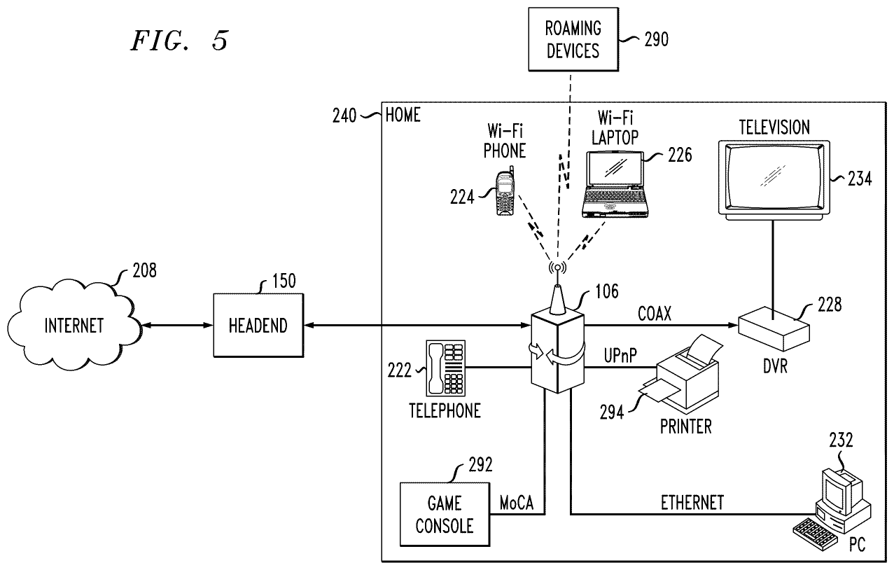

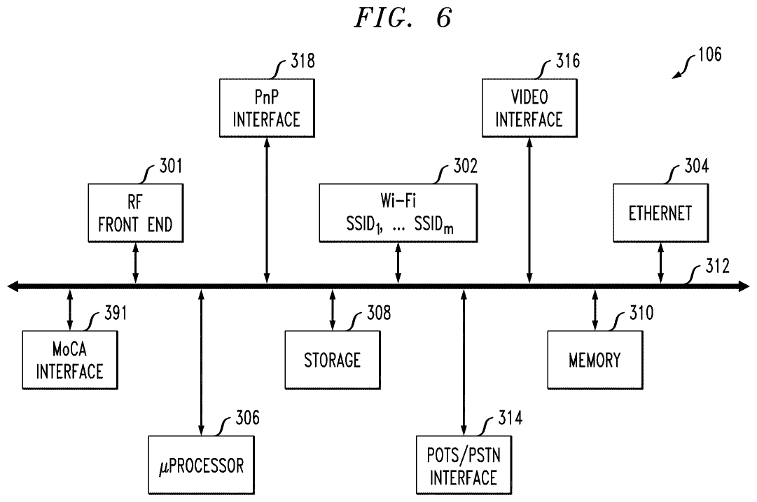

Reference should now be had to FIG. 5, which presents a block diagram of a premises network interfacing with a head end of an MSO or the like, providing Internet access. An exemplary advanced wireless gateway comprising CPE 106 is depicted as well. It is to be emphasized that the specific form of CPE 106 shown in FIGS. 5 and 6 is exemplary and non-limiting, and shows a number of optional features. Many other types of CPE can be employed in one or more embodiments; for example, a cable modem, DSL modem, and the like. The CPE can also be a Service Optical Network Unit (S-ONU) for FTTH deployment-see FIGS. 8 and 9 and accompanying text.

CPE 106 includes an advanced wireless gateway which connects to a head end 150 or other hub of a network, such as a video content network of an MSO or the like. The head end is coupled also to an internet (e.g., the Internet) 208 which is located external to the head end 150, such as via an Internet (IP) backbone or gateway (not shown).

The head end is in the illustrated embodiment coupled to multiple households or other premises, including the exemplary illustrated household 240. In particular, the head end (for example, a cable modem termination system 156 thereof) is coupled via the aforementioned HFC network and local coaxial cable or fiber drop to the premises, including the consumer premises equipment (CPE) 106. The exemplary CPE 106 is in signal communication with any number of different devices including, e.g., a wired telephony unit 222, a Wi-Fi or other wireless-enabled phone 224, a Wi-Fi or other wireless-enabled laptop 226, a session initiation protocol (SIP) phone, an H.323 terminal or gateway, etc. Additionally, the CPE 106 is also coupled to a digital video recorder (DVR) 228 (e.g., over coax), in turn coupled to television 234 via a wired or wireless interface (e.g., cabling, PAN or 802.15 UWB micro-net, etc.). CPE 106 is also in communication with a network (here, an Ethernet network compliant with IEEE Std. 802.3, although any number of other network protocols and topologies could be used) on which is a personal computer (PC) 232.

Other non-limiting exemplary devices that CPE 106 may communicate with include a printer 294; for example, over a universal plug and play (UPnP) interface, and/or a game console 292; for example, over a multimedia over coax alliance (MoCA) interface.

In some instances, CPE 106 is also in signal communication with one or more roaming devices, generally represented by block 290.

A “home LAN” (HLAN) is created in the exemplary embodiment, which may include for example the network formed over the installed coaxial cabling in the premises, the Wi-Fi network, and so forth.

During operation, the CPE 106 exchanges signals with the head end over the interposed coax (and/or other, e.g., fiber) bearer medium. The signals include e.g., Internet traffic (IPv4 or IPv6), digital programming and other digital signaling or content such as digital (packet-based; e.g., VoIP) telephone service. The CPE 106 then exchanges this digital information after demodulation and any decryption (and any demultiplexing) to the particular system(s) to which it is directed or addressed. For example, in one embodiment, a MAC address or IP address can be used as the basis of directing traffic within the client-side environment 240.

Any number of different data flows may occur within the network depicted in FIG. 5. For example, the CPE 106 may exchange digital telephone signals from the head end which are further exchanged with the telephone unit 222, the Wi-Fi phone 224, or one or more roaming devices 290. The digital telephone signals may be IP-based such as Voice-over-IP (VoIP), or may utilize another protocol or transport mechanism. The well-known session initiation protocol (SIP) may be used, for example, in the context of a “SIP phone” for making multi-media calls. The network may also interface with a cellular or other wireless system, such as for example a 3G IMS (IP multimedia subsystem) system, in order to provide multimedia calls between a user or consumer in the household domain 240 (e.g., using a SIP phone or H.323 terminal) and a mobile 3G telephone or personal media device (PMD) user via that user's radio access network (RAN).

The CPE 106 may also exchange Internet traffic (e.g., TCP/IP and other packets) with the head end 150 which is further exchanged with the Wi-Fi laptop 226, the PC 232, one or more roaming devices 290, or other device. CPE 106 may also receive digital programming that is forwarded to the DVR 228 or to the television 234. Programming requests and other control information may be received by the CPE 106 and forwarded to the head end as well for appropriate handling.

FIG. 6 is a block diagram of one exemplary embodiment of the CPE 106 of FIG. 5. The exemplary CPE 106 includes an RF front end 301, Wi-Fi interface 302, video interface 316, “Plug n' Play” (PnP) interface 318 (for example, a UPnP interface) and Ethernet interface 304, each directly or indirectly coupled to a bus 312. In some cases, Wi-Fi interface 302 comprises a single wireless access point (WAP) running multiple (“m”) service set identifiers (SSIDs). In some cases, multiple SSIDs, which could represent different applications, are served from a common WAP. For example, SSID 1 is for the home user, while SSID 2 may be for a managed security service, SSID 3 may be a managed home networking service, SSID 4 may be a hot spot, and so on. Each of these is on a separate IP subnetwork for security, accounting, and policy reasons. The microprocessor 306, storage unit 308, plain old telephone service (POTS)/public switched telephone network (PSTN) interface 314, and memory unit 310 are also coupled to the exemplary bus 312, as is a suitable MoCA interface 391. The memory unit 310 typically comprises a random-access memory (RAM) and storage unit 308 typically comprises a hard disk drive, an optical drive (e.g., CD-ROM or DVD), NAND flash memory, RAID (redundant array of inexpensive disks) configuration, or some combination thereof.

The illustrated CPE 106 can assume literally any discrete form factor, including those adapted for desktop, floor-standing, or wall-mounted use, or alternatively may be integrated in whole or part (e.g., on a common functional basis) with other devices if desired.

Again, it is to be emphasized that every embodiment need not necessarily have all the elements shown in FIG. 6—as noted, the specific form of CPE 106 shown in FIGS. 5 and 6 is exemplary and non-limiting, and shows a number of optional features. Yet again, many other types of CPE can be employed in one or more embodiments; for example, a cable modem, DSL modem, and the like.

It will be recognized that while a linear or centralized bus architecture is shown as the basis of the exemplary embodiment of FIG. 6, other bus architectures and topologies may be used. For example, a distributed or multi-stage bus architecture may be employed. Similarly, a “fabric” or other mechanism (e.g., crossbar switch, RAPIDIO interface, non-blocking matrix, TDMA or multiplexed system, etc.) may be used as the basis of at least some of the internal bus communications within the device. Furthermore, many if not all of the foregoing functions may be integrated into one or more integrated circuit (IC) devices in the form of an ASIC or “system-on-a-chip” (SoC). Myriad other architectures well known to those in the data processing and computer arts may accordingly be employed.

Yet again, it will also be recognized that the CPE configuration shown is essentially for illustrative purposes, and various other configurations of the CPE 106 are consistent with other embodiments of the invention. For example, the CPE 106 in FIG. 6 may not include all of the elements shown, and/or may include additional elements and interfaces such as for example an interface for the HomePlug A/V standard which transmits digital data over power lines, a PAN (e.g., 802.15), Bluetooth, or other short-range wireless interface for localized data communication, etc.

A suitable number of standard 10/100/1000 Base T Ethernet ports for the purpose of a Home LAN connection are provided in the exemplary device of FIG. 6; however, it will be appreciated that other rates (e.g., Gigabit Ethernet or 10-Gig-E) and local networking protocols (e.g., MoCA, USB, etc.) may be used. These interfaces may be serviced via a WLAN interface, wired RJ-45 ports, or otherwise. The CPE 106 can also include a plurality of RJ-11 ports for telephony interface, as well as a plurality of USB (e.g., USB 2.0) ports, and IEEE-1394 (Firewire) ports. S-video and other signal interfaces may also be provided if desired.

During operation of the CPE 106, software located in the storage unit 308 is run on the microprocessor 306 using the memory unit 310 (e.g., a program memory within or external to the microprocessor). The software controls the operation of the other components of the system, and provides various other functions within the CPE. Other system software/firmware may also be externally reprogrammed, such as using a download and reprogramming of the contents of the flash memory, replacement of files on the storage device or within other non-volatile storage, etc. This allows for remote reprogramming or reconfiguration of the CPE 106 by the MSO or other network agent.

It should be noted that some embodiments provide a cloud-based user interface, wherein CPE 106 accesses a user interface on a server in the cloud, such as in NDC 1098.

The RF front end 301 of the exemplary embodiment comprises a cable modem of the type known in the art. In some cases, the CPE just includes the cable modem and omits the optional features. Content or data normally streamed over the cable modem can be received and distributed by the CPE 106, such as for example packetized video (e.g., IPTV). The digital data exchanged using RF front end 301 includes IP or other packetized protocol traffic that provides access to internet service. As is well known in cable modem technology, such data may be streamed over one or more dedicated QAMs resident on the HFC bearer medium, or even multiplexed or otherwise combined with QAMs allocated for content delivery, etc. The packetized (e.g., IP) traffic received by the CPE 106 may then be exchanged with other digital systems in the local environment 240 (or outside this environment by way of a gateway or portal) via, e.g., the Wi-Fi interface 302, Ethernet interface 304 or plug-and-play (PnP) interface 318.

Additionally, the RF front end 301 modulates, encrypts/multiplexes as required, and transmits digital information for receipt by upstream entities such as the CMTS or a network server. Digital data transmitted via the RF front end 301 may include, for example, MPEG-2 encoded programming data that is forwarded to a television monitor via the video interface 316. Programming data may also be stored on the CPE storage unit 308 for later distribution by way of the video interface 316, or using the Wi-Fi interface 302, Ethernet interface 304, Firewire (IEEE Std. 1394), USB/USB2, or any number of other such options.

Other devices such as portable music players (e.g., MP3 audio players) may be coupled to the CPE 106 via any number of different interfaces, and music and other media files downloaded for portable use and viewing.

In some instances, the CPE 106 includes a DOCSIS cable modem for delivery of traditional broadband Internet services. This connection can be shared by all Internet devices in the premises 240; e.g., Internet protocol television (IPTV) devices, PCs, laptops, etc., as well as by roaming devices 290. In addition, the CPE 106 can be remotely managed (such as from the head end 150, or another remote network agent) to support appropriate IP services. Some embodiments could utilize a cloud-based user interface, wherein CPE 106 accesses a user interface on a server in the cloud, such as in NDC 1098.

In some instances, the CPE 106 also creates a home Local Area Network (LAN) utilizing the existing coaxial cable in the home. For example, an Ethernet-over-coax based technology allows services to be delivered to other devices in the home utilizing a frequency outside (e.g., above) the traditional cable service delivery frequencies. For example, frequencies on the order of 1150 MHz could be used to deliver data and applications to other devices in the home such as PCs, PMDs, media extenders and set-top boxes. The coaxial network is merely the bearer; devices on the network utilize Ethernet or other comparable networking protocols over this bearer.

The exemplary CPE 106 shown in FIGS. 5 and 6 acts as a Wi-Fi access point (AP), thereby allowing Wi-Fi enabled devices to connect to the home network and access Internet, media, and other resources on the network. This functionality can be omitted in one or more embodiments.

In one embodiment, Wi-Fi interface 302 comprises a single wireless access point (WAP) running multiple (“m”) service set identifiers (SSIDs). One or more SSIDs can be set aside for the home network while one or more SSIDs can be set aside for roaming devices 290.

A premises gateway software management package (application) is also provided to control, configure, monitor and provision the CPE 106 from the cable head-end 150 or other remote network node via the cable modem (DOCSIS) interface. This control allows a remote user to configure and monitor the CPE 106 and home network. Yet again, it should be noted that some embodiments could employ a cloud-based user interface, wherein CPE 106 accesses a user interface on a server in the cloud, such as in NDC 1098. The MoCA interface 391 can be configured, for example, in accordance with the MoCA 1.0, 1.1, or 2.0 specifications.

As discussed above, the optional Wi-Fi wireless interface 302 is, in some instances, also configured to provide a plurality of unique service set identifiers (SSIDs) simultaneously. These SSIDs are configurable (locally or remotely), such as via a web page.

As noted, there are also fiber networks for fiber to the home (FTTH) deployments (also known as fiber to the premises or FTTP), where the CPE is a Service ONU (S-ONU; ONU=optical network unit). Referring now to FIG. 8, L3 network 802 generally represents the elements in FIG. 1 upstream of the head ends 150, while head end 804, including access router 806, is an alternative form of head end that can be used in lieu of or in addition to head ends 150 in one or more embodiments. Head end 804 is suitable for FTTH implementations. Access router 806 of head end 804 is coupled to optical line terminal 812 in primary distribution cabinet 810 via dense wavelength division multiplexing (DWDM) network 808. Single fiber coupling 814 is then provided to a 1:64 splitter 818 in secondary distribution cabinet 816 which provides a 64:1 expansion to sixty-four S-ONUs 822-1 through 822-64 (in multiple premises) via sixty-four single fibers 820-1 through 820-64, it being understood that a different ratio splitter could be used in other embodiments and/or that not all of the 64 (or other number of) outlet ports are necessarily connected to an S-ONU.

Giving attention now to FIG. 9, wherein elements similar to those in FIG. 8 have been given the same reference number, access router 806 is provided with multiple ten-Gigabit Ethernet ports 999 and is coupled to OLT 812 via L3 (layer 3) link aggregation group (LAG) 997. OLT 812 can include an L3 IP block for data and video, and another L3 IP block for voice, for example. In a non-limiting example, S-ONU 822 includes a 10 Gbps bi-directional optical subassembly (BOSA) on-board transceiver 993 with a 10G connection to system-on-chip (SoC) 991. SoC 991 is coupled to a 10 Gigabit Ethernet RJ45 port 979, to which a high-speed data gateway 977 with Wi-Fi capability is connected via category 5E cable. Gateway 977 is coupled to one or more set-top boxes 975 via category 5e, and effectively serves as a wide area network (WAN) to local area network (LAN) gateway. Wireless and/or wired connections can be provided to devices such as laptops 971, televisions 973, and the like, in a known manner. Appropriate telephonic capability can be provided. In a non-limiting example, residential customers are provided with an internal integrated voice gateway (I-ATA or internal analog telephone adapter) 983 coupled to SoC 991, with two RJ11 voice ports 981 to which up to two analog telephones 969 can be connected. Furthermore, in a non-limiting example, business customers are further provided with a 1 Gigabit Ethernet RJ45 port 989 coupled to SoC 991, to which switch 987 is coupled via Category 5e cable. Switch 987 provides connectivity for a desired number n (typically more than two) of analog telephones 967-1 through 967-n, suitable for the needs of the business, via external analog telephone adapters (ATAs) 985-1 through 985-n. The parameter “n” in FIG. 9 is not necessarily the same as the parameter “n” in other figures, but rather generally represents a desired number of units. Connection 995 can be, for example, via SMF (single-mode optical fiber).

In addition to “broadcast” content (e.g., video programming), the systems of FIGS. 1-6, 8, and 9 can, if desired, also deliver Internet data services using the Internet protocol (IP), although other protocols and transport mechanisms of the type well known in the digital communication art may be substituted. In the systems of FIGS. 1-6, the IP packets are typically transmitted on RF channels that are different that the RF channels used for the broadcast video and audio programming, although this is not a requirement. The CPE 106 are each configured to monitor the particular assigned RF channel (such as via a port or socket ID/address, or other such mechanism) for IP packets intended for the subscriber premises/address that they serve. Furthermore, one or more embodiments could be adapted to situations where a cable/fiber broadband operator provides wired broad band data connectivity but does not provide QAM-based broadcast video.

Principles of the present disclosure will be described herein in the context of apparatus, systems, and methods for detecting and mitigating malicious network traffic. It is to be appreciated, however, that the specific apparatus and/or methods illustratively shown and described herein are to be considered exemplary as opposed to limiting. Moreover, it will become apparent to those skilled in the art given the teachings herein that numerous modifications can be made to the embodiments shown that are within the scope of the appended claims. That is, no limitations with respect to the embodiments shown and described herein are intended or should be inferred.

One or more embodiments provide a small form factor pluggable device that applies a pre-defined set of DDoS mitigation techniques and countermeasures to all traffic passing through it; essentially a pluggable network device that acts as a very basic stateless firewall for DDoS attack traffic. In one example embodiment, a small form-factor, pluggable device (SFP), such as an unmanaged and active optical transceiver, is configured to interface with a plurality of network devices, such as a router, a switch, a firewall, a server, a network, a network device and the like, and to detect and mitigate malicious network traffic, such as network traffic associated with a DDoS attack. For the avoidance of doubt, the SFP is typically capable of interfacing with many different types of network/hardware devices, but does not necessarily interface with more than one such device at a time. Indeed, generally, the SFP can interface with many different types of network gear; there is normally a standard sizing and form factor that all the network hardware vendors adhere to for the SFP ports of most devices. Current SFP transceivers are not standardized by any official standards body but rather by a multi-source agreement (MSA) among the competing manufacturers.

Furthermore in this regard, the MSA is a multi-vendors specification defining the transceiver form-factors (dimensions, electrical-connector, pinout, etc.) as well as the management interface, also called 2 wire interface. The MSA enables the interoperability between transceivers vendors and switches/routers vendors. While the skilled artisan will be familiar with the SFP MSA, out of an abundance of caution, the following documents are hereby expressly incorporated herein in their entireties for all purposes:

SFF Committee, INF-8074i Specification for SFP (Small Formfactor Pluggable) Transceiver Rev 1.0 May 12, 2001;

SFF-8024 Specification for SFF Cross Reference to Industry Products Rev 4.2 Mar. 28, 2017;

SFF Committee, SFF-8079 Specification for SFP Rate and Application Selection Rev 1.7 Feb. 2, 2005;

SFF Committee, SFF-8089 Specification for SFP (Small Formfactor Pluggable) Rate and Application Codes Rev 1.3 Feb. 3, 2005;

SFF Committee, SFF-8431 Specification for SFP+ 10 Gb/s and Low Speed Electrical Interface Rev 4.1 Jul. 6, 2009 and Rev 4.1 Addendum Sep. 15, 2013;

SFF Committee, SFF-8432 Specification for SFP+ Module and Cage, Rev 5.1 Aug. 8, 2012;

SFF Committee, SFF-8472 Specification for Diagnostic Monitoring Interface for Optical Transceivers, Rev 12.2 Nov. 21, 2014; and

SFF Committee, Specification for Tunable SFP+ Memory Map for ITU Frequencies Rev 1.4 Jan. 23, 2013.

As will be appreciated by the skilled artisan, referring to the above-mentioned specification documents, an SFP device will typically be located in a housing with dimensions as set forth at pages 6 and 7 of SFF Committee, INF-8074i Specification for SFP (Small Formfactor Pluggable) Transceiver Rev 1.0 May 12, 2001, such as having a front width of 13.7±0.1 mm; a front height of 8.6±0.1 mm; a rear height of 8.5±0.1 mm; a rear length of 13.4±0.1 mm; and an overall length of about 56.5 mm. For simplicity, one or more embodiments will have a height of less than 10 mm, a width less than 15 mm, and a length less than 60 mm. Connectors can include electrical connectors and optical connectors. The former can, typically, include metallic network connectors such as copper e.g., Ethernet connectors. The latter can include optical fiber connectors such as single mode, multimode, simplex, and/or duplex.

In one example embodiment, the SFP is also configured to provide a bridge between two transmission mediums (such as copper, fiber, and the like), two transmission protocols (such as Internet Protocol (IP), DOCSIS, and the like), or any combination thereof and to translate communications from a transmission medium of a received signal to a transmission medium of a downstream piece of network equipment and/or to translate communications from a transmission medium of a piece of network equipment (e.g., CPE) to a signal to be transmitted upstream into a network. The transmission medium of the transmitter and the receiver may be the same or may be different. For example, paths in the SFP can be configured for electrical to optical, optical to electrical, or electrical to electrical (e.g., incoming copper SFP electrical and outgoing to router as electrical). Conventionally, unintelligent devices that simply transform a signal from one format to another are not capable of providing firewall/security functionality.

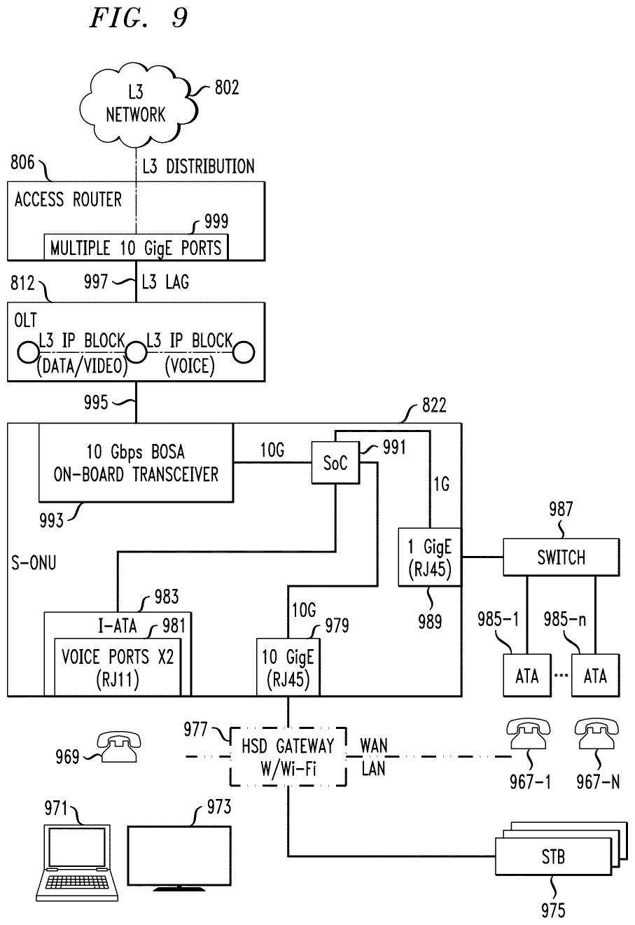

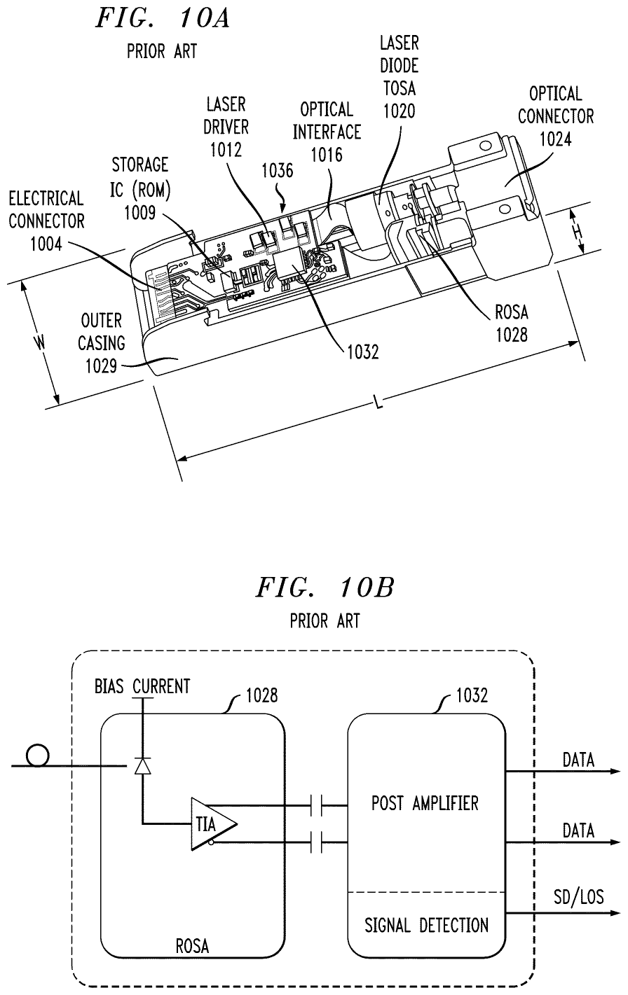

FIG. 10A is an illustration of a conventional SFP device 1099. The SFP device 1099 typically includes a small circuit board 1036, a storage memory device 1009 (such as a read-only memory or ROM), one or more amplifiers 1032, and various other components which convert the incoming and outgoing signals from optical to electrical signals and vice versa. The primary function of the receive optical sub-assembly (ROSA) 1028 is to convert the incoming optical signal (received via optical connector 1024 and optical interface 1016) to an electrical signal (transmitted via electrical connector 1004). Other components may be included to, for example, reshape input signals that have been degraded by long-distance transmission and to transmit information in the other direction (such as a laser driver 1012 and a laser diode transmit optical subassembly (TOSA) 1020). A set of amplifiers 1032 may include a preamplifier for converting a current signal to a voltage signal and amplifying the signal to a high voltage gain, while a post-amplifier may be used to equalize the output signal of the preamplifier to an amplitude level suitable for input. The unit is housed in an outer casing 1029.

FIG. 10B is a high-level block diagram of the receive optical sub-assembly (ROSA) 1028 and the post-amplifier 1032 of the conventional SFP device 1099. A transimpedance amplifier TIA amplifies current of from a photo detector that receives an optical signal and converts it to an electrical signal, which is then further amplified by the post amplifier 1032. In FIG. 10B, SD=signal detection and LOS=loss of signal. The LOS block refers to a condition when the link itself goes down and the LOS block sends a “dying gasp” which informs another device that the device of FIG. 10B is about to go down, as will be familiar to the skilled artisan. A differential data output is generated by the post amplifier 1032 and provided for transmission via the electrical connector 1004. Generally, within a fiber-optic link, the optical subassembly converts the data signal from an electrical current to light in the fiber and vice versa. In the case of the transmitter (TOSA), the electro-optic active element is, for example, a light-emitting diode, edge-emitting laser diode, or vertical cavity surface-emitting laser. In the case of the receiver (ROSA), the electro-optic active element is, for example, the photo detector, such as a positive-intrinsic-negative diode or an avalanche photodiode.

Referring to FIG. 11, in one example embodiment, firewall functionality is incorporated into, for example, an application specific integrated circuit (ASIC), field-programmable gate array (FPGA), or the like, generally designated as 1101, embedded into the SFP 1100. In general, the SFP 1100 provides ubiquitous, best practice security by dropping (or throttling) DDoS traffic based on hardware-based (hardwired) rules within the SFP 1100. The small, stateless hardware-based firewall provided by the SFP 1100 has a conventional SFP form factor (see discussion of housing dimensions from relevant specifications, and simplified, above) and serves to provide firewall capabilities and/or to offload a portion of the firewall processing performed by a corresponding conventional firewall apparatus, router, switch, server, and the like. The SFP 1100 has at least one receive connector and at least one transmit connector, such as a connector for a copper line, a connector for a fiber line, and the like (can be similar to those shown in FIG. 10A). In one example embodiment, the SFP 1100 supports transmission paths in both directions between the two transmission mediums, whether via a single bidirectional transmission medium or two unidirectional transmission mediums (duplex). In the case of an SFP 1100 that supports transmission paths in both directions, the above described “firewall” functionality may be implemented in one direction or both directions.

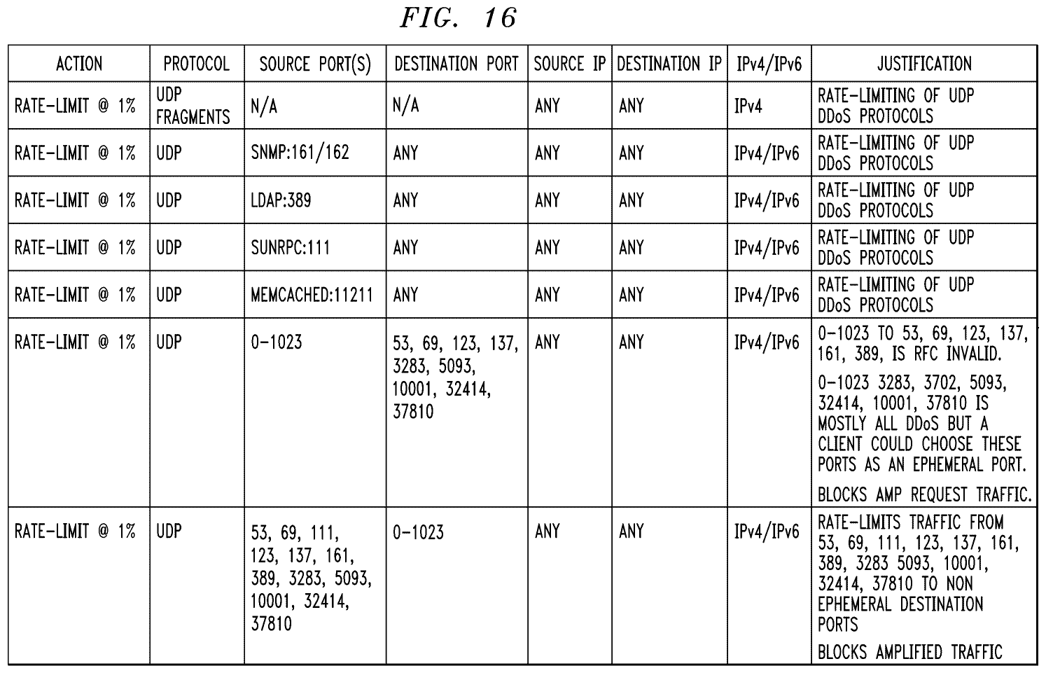

FIG. 11 is thus a high-level block diagram of an unmanaged and active SFP device 1100 and a corresponding network hardware device 1104, in accordance with an example embodiment. In one example embodiment, the SFP device 1100 receives inbound traffic via an optical or electrical signal. The inbound traffic may include both “good” (non-malicious) traffic and “bad” (malicious) traffic. In one example embodiment, the SFP device 1100 inspects the headers of incoming network traffic, matches the header against a ruleset (such as in terms of matching ports, matching protocols, and the like—see FIG. 15 and accompanying text), blocks the network traffic that satisfies the criteria of one or more rules of the ruleset dedicated to access control (such as network traffic known to be malicious) and forwards the remaining “good” traffic to the network hardware device 1104. In one example embodiment, the ruleset defines a security access control list (ACL) where any packet matching an ACL rule is blocked. The unblocked (“good”) traffic is forwarded to, for example, a network hardware device 1104, such as a router, a switch, a firewall, a server, and the like.

Indeed, still with reference to FIG. 11, in one or more embodiments the “miniature firewall” is implemented in hardware within the transceiver unit/pluggable optic—the same includes a circuit board with an ASIC or the like. The inbound traffic is inspected by the miniature firewall built into the SFP and applies the rulesets as an ACL to all traffic ingress, blocking known malicious DDoS signatures (in a stateless manner) before the router/switch/server or other hardware device has to process it. Thus, while modern conventional firewalls typically keep track of the connection state, one or more embodiments provide an unmanaged and active stateless firewall with hard-coded, pre-configured rules.

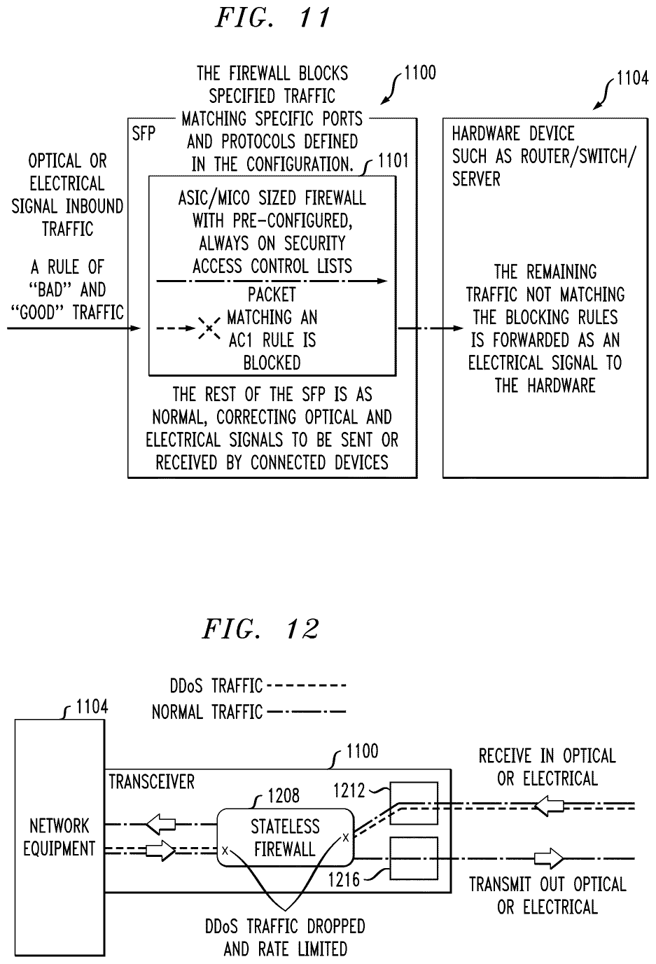

FIG. 12 is a mid-level block diagram of the unmanaged and active SFP device 1100, in accordance with an example embodiment. In one example embodiment, a hardware device 1208, such as an application-specific integrated circuit (ASIC), a field-programmable gate array (FPGA), and the like, implements a stateless firewall and performs the inspection of the headers of incoming network traffic, matching of the header against a ruleset, blocking/throttling of the network traffic that satisfies the criteria of one or more rules of the ruleset, and forwarding the remaining “good” traffic. The hardware device 1208 can reside, for example, between the network device 1104 and a receiver interface 1212 to protect from incoming DDoS traffic and/or between the network device 1104 and a transmitter interface 1216 to protect from DDoS attacks being initiated within a network, such as by a customer of an Internet Service Provider (ISP) who is engaging in malevolent actions.

The SFP 1100 may be deployed in a variety of locations within a network or at a network boundary. For example, the SFP 1100 may be placed in an NDC 1098 between the Internet 1002 (generally, the outside, untrusted world) and a network device within the NDC 1098, between the Internet 1002 and a router 1008, where a head end 150 connects to the NDC 1098, by a CPE device 106 or S-ONU 822 (e.g., to protect the CPE/S-ONU from external DDoS and/or to protect the upstream world from a DDoS attach initiated using the CPE/S-ONU), the protect the access router 806, and the like. In the case of the S-ONU, the SFP 1100 can be located between OLT 812 and transceiver 993, for example. In the case of the access router 806, the SFP 1100 can be located between L3 network 802 and headend 804, for example. In general, it is advantageous to locate the SFP 1100 as close to the source of the DDoS attack as possible.

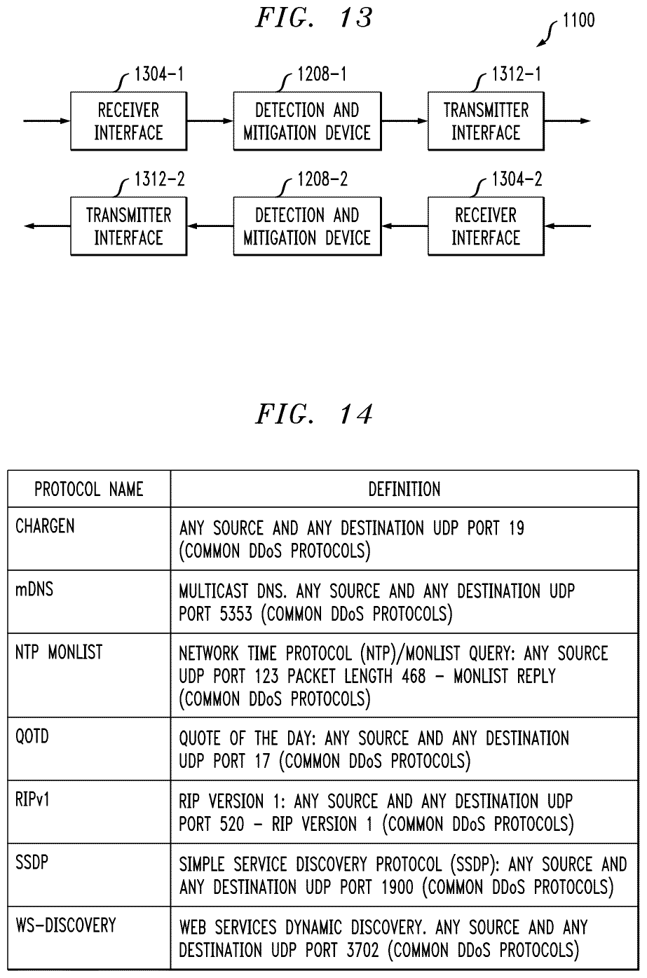

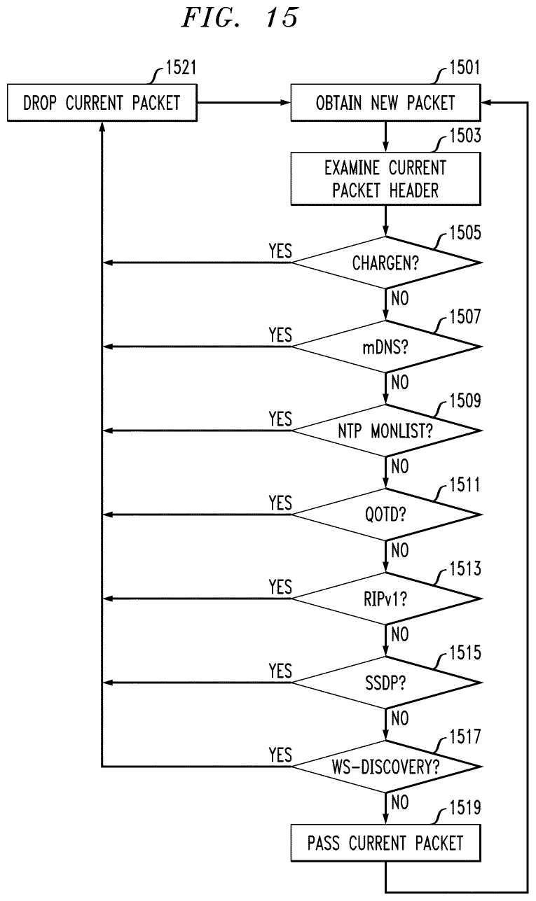

FIG. 13 is a block diagram of the unmanaged and active SFP device 1100, in accordance with an example embodiment. In one example embodiment, a detection and mitigation device 1208-1 implements a stateless firewall and performs the inspection of the headers of incoming network traffic, matching of the header against a ruleset, blocking of the network traffic that satisfies the criteria of one or more rules of the ruleset, and forwarding of the remaining ‘good’ traffic. In one example embodiment, the hardware device is implemented with an application-specific integrated circuit (ASIC), field-programmable gate array (FPGA), and the like, and resides between a receiver interface 1304-1 and a transmitter interface 1312-1. If the stateless firewall is to be implemented in both transmission directions, a second detection and mitigation device 1208-2 is positioned between a receiver interface 1304-2 and a transmitter interface 1312-2. It is noted that the detection and mitigation device 1208-2 may be implemented in the same hardware device as the detection and mitigation device 1208-1 or in a different hardware device. What is encompassed by the “network interface receiver” and “network interface transmitter” of FIG. 14 will depend on the type of transmission medium: optical, electrical, wireless, etc. In one or more embodiments, the same covers the components between the transmission medium and the (e.g., parallel, but could be serial in some circumstances) data interface of the hardware device 1208. Generally, the Rx/Tx (receiver/transmitter) includes all of FIG. 10B and FIG. 10A, except the storage memory device 1009 and portions of the circuit board 1036, and also includes the ASIC/FPGA.

FIG. 14 is a table of example rules for detecting and mitigating malicious network traffic, in accordance with an example embodiment. The rules may define, for example, a set of User Datagram Protocol (UDP) ports. With the exception of the RIPv1 rule, the rules of FIG. 14 provide criteria for identifying network traffic that is only used in, for example, DDoS attacks. The skilled artisan will be familiar with RIPv1 (Routing Information Protocol Version 1), which is used in the edge CMTS infrastructure for routing traffic. In terms of ‘internet’ traffic, however, RIPv1 should not appear or be permitted in or out due to a potential DDoS vulnerability, which is why it appears in the table of FIG. 14. There is a RIPv2 that does not include the DDoS vulnerability which should be used instead. It should be noted that while it is generally deemed advisable to block RIPv1, it would typically not be appropriate to place a RIPv1 blocking filter within a current CMTS infrastructure where it is currently being used in a manner that does not exhibit a security vulnerability. Of course, if a CMTS infrastructure moves away from RIPv1, an RIPv1 blocking filter could then be located within such infrastructure.

The packet headers of packets arriving into the SFP 1100 are evaluated to determine if they meet the criteria of one or more of the rules. In one example embodiment, the rules inplement an Access Control List, and the SFP 1100 specifically targets known DDoS traffic. Modern firewalls, on the other hand, keep track of the state of connections whereas, in one example embodiment, the SFP 1100 is an unmanaged and active, stateless firewall with preconfigured rules that are hardcoded (i.e., ASIC or FPGA is specifically programmed to drop/throttle the ports/protocols). The inbound packets identified by the rules of FIG. 14 are conventionally blocked by software-based firewalls at, for example, an Internet service provider's (ISP's) peering edge. It is worth noting that in one or more embodiments, the SFP can be considered, in one sense, as “active” as opposed to “passive,” since the ASIC is an active device. However, while the addition of rules in accordance with one or more embodiments makes the SFP a more active device, since it is not actively managed in one or more embodiments, the SFP device is ‘passive’ from a networking hardware perspective. Conversely, a ‘passive’ tap device performs traffic mirroring without disturbing the traffic flow, and so can be referred to as “active” from that standpoint. In this regard, the terminology “unmanaged and active” can be employed. Stated in another way, the device is unmanaged in that it sits in the network and acts on traffic without human intervention, but is active in the sense that it acts on traffic that goes through it. One or more embodiments are believed to be particularly advantageous for 10 Gbps or lower interface speed optics, since the higher the throughput, the more processing power is required to inspect the headers. Of course, one or more embodiments can be used at higher speed if desired but it could be difficult to include sufficient processing power into an SFP module.

The traffic types identified by rules of the ruleset are known to be malicious traffic types of which the only effective use is in, for example, DDoS amplification and reflection attacks. There are no valid uses for these traffic types across the Internet and, as such, an advantageous place for these rules to be applied is at the Internet edges, at the customer premises edge, at the internet peering edge, and the like. Current approaches typically block all the defined traffic types using an ACL on edge routers. Current approaches typically block this traffic incoming from customers at the customer premises edge, as well as going towards customers and infrastructure at the internet peering edge. In one or more embodiments, the list, such as the list of FIG. 14, is static and does not need to change in the foreseeable future.

FIG. 15 is a flow chart of logic implemented by an unmanaged and active SFP device according to exemplary embodiments; the process is essentially continuous. A new packet is obtained at 1501 and becomes the current packet, the header of which is inspected/examined at 1503. At each of the decision blocks 1505, 1507, 1509, 1511, 1513, 1515, 1517, a determination is made whether the indicated inappropriate protocol from FIG. 14 is present in the header of the current packet. If the answer at any stage is “YES,” the current packet is dropped 1521 and the next new packet is obtained at 1501. If the answer at any stage is “NO,” flow control proceeds to the next decision block and if all yield a “NO,” the current packet is passed at 1519 and the next new packet is obtained at 1501.

There are many suppliers of conventional SFP devices, such as ProLabs Ltd., Tustin, California, USA; PRECISION OPTICAL TRANSCEIVERS, INC., Rochester, NY, USA; Cogent Sourcing, Anaheim, CA, USA; and Coherent Corp., Saxonburg, PA, USA. Furthermore, most of the network equipment makers (such as Juniper Networks, Inc., Sunnyvale, California, USA; Cisco Systems, Inc., San Jose, California, USA; and Nokia Corporation, Espoo, Finland) also make their own OEM optical transceivers. The hardware is usually the same with different coded software on the transceiver itself. Non-limiting examples of pertinent types of transceivers include 1G-Copper-SFP, 1G-SR-SFP, 1G-LR-SFP, 10G-LR-SFP+, 10G-SR-SFP+, 40G-QSFP, 100G-QSFP, and the like. SR stands for short reach and is usually connected with a multimode fiber, and LR stands for long reach and is typically connected with a Single Mode fiber. Copper SFPs take in a copper connection such as Ethernet/CAT5/CAT6.

Thus, one or more embodiments enhance the functionality of an SFP device that plugs into a router, switch, server or the like and changes an optical signal to an electrical signal or vice-versa. In one or more embodiments, the enhanced SFP is an unmanaged and active device which mechanistically translates media and drops DDoS traffic. The enhanced SFP moves some security activity from a router, switch, server, firewall, or the like to the SFP, advantageously blocking DDoS traffic before it even reaches the hardware device 1104. In one or more embodiments, a known SFP device can be modified internally as described herein and no change is needed to the corresponding hardware device 1104 or other network devices and components.

Referring again to FIGS. 10A, 10B, 12, and 13, one or more embodiments modify an SFP device by interposing stateless firewall 1208, 1208-1 downstream of the receiver 1212 (see elements 1028, 1032)/receiver interface 1304-2, which converts the incoming optical signal into an electrical signal and then amplifies the electrical signal, and upstream of the transmitter interface 1312-1 and network equipment 1103 to be protected.

One or more embodiments are implemented in a non-configurable hardware approach, but could be used with other, external, configurable security measures.

One or more embodiments consider packet headers without the need for or use of deep packet inspection (similarly, other security measures that do use deep packet inspection could be used externally in conjunction with aspects of the invention).

Given the appropriate rules and logic (such as FIGS. 14 and 15) and the teachings herein, the skilled artisan can implement the stateless firewall using hardware (e.g., ASIC, FPGA; for example, adding an ASIC or FPGA to an existing SFP. Given the teachings herein, the skilled artisan will be able to implement the desired logic in an ASIC or FPGA by adapting known techniques, such as by use of electronic design automation tools and a hardware description language (HDL), such as Verilog or VHDL, to describe the functionality of the ASIC or FPGA.

As noted embodiments could be implemented only on the receive side, only on the transmit side, or on both the receive and transmit sides.

One or more embodiments thus build into the SFP/Transceiver a basic stateless firewall configured to read the incoming and outgoing packet headers and apply a pre-defined, hard-coded ruleset to all traffic (in some cases, bidirectionally) without relying on router access control lists, without consuming excessive CPU cycles (when a router processes the traffic with an ACL, it costs a bit of performance on the router itself in terms of CPU cycles to look up against the connection table and the ACL and drop the corresponding packets-applying many ACLs to a router causes a performance hit in terms of CPU cycles), and/or without use of expensive redirection options. For example, an ASIC is inserted between the post amp and the electrical connector on the receive side in order to inspect the headers of incoming traffic, match against a ruleset, and block certain known bad traffic before forwarding the remaining ‘good’ traffic to the equipment. A pertinent use case for one or more embodiments is between a trusted network or network of networks and its connection to the public Internet or other untrusted network or network of networks, as the pre-defined rules explicitly prevent aspects of DDoS traffic to and from the Internet. In one or more embodiments, the device is configured to drop traffic matching certain common DDoS ports and protocols, as well as to rate-limit other traffic which should not be dropped entirely. Rate-limiting can be pre-configured to occur at 1% of the optical transceiver's negotiated link speed, or at some other suitable percentage.

The table of FIG. 14 shows a non-limiting example of traffic that is to be dropped. Generally, such traffic can be defined as the following Source or Destination UDP port:

19, 5353, 123 with packet length 468, 17, 520, 1900, 3702

Source port 80 or Source port 443, and destination ports 53, 69, 111, 123, 137, 161, or 389

Source ports 53, 68, 111, 123, 137, 161, 389 and destination ports 80 or 443

Any other traffic matching the following parameters and that is exceeding 1% (or other configurable percentage) of the negotiated transceiver link speed is rate-limited (dropped)

UDP source ports: 161, 162, 389, 111, 11211

By eliminating these traffic types, we project that in one or more embodiments, DDoS attack traffic will be reduced by 60-90% or more depending on the sophistication of the attack. In one or more embodiments, the pluggable device does not contain an IP address and is configured such that it is not able to be remotely managed.

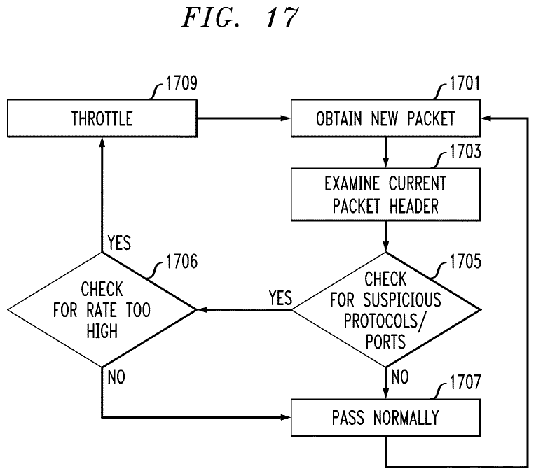

In addition to some traffic to be dropped completely, in another aspect, referring to FIG. 16, any other traffic matching the indicated parameters and that is exceeding 1% (or other configurable percentage) of the negotiated transceiver link speed is rate-limited (throttled). Thus, FIG. 14 represents dropping certain types of traffic while FIG. 16 gives a separate list of different protocols that should not be dropped completely because there is some legitimate traffic sent on those protocols-instead of completely dropping, those protocols are rate-limited. This is appropriate because there is typically never a scenario for such a protocol (e.g., LDAP) where, say, 1% of the interface is required to be LDAP traffic because LDAP traffic is typically very low volume. If LDAP traffic is ever seen in large volumes it is likely to be a DDoS attack-since it is not appropriate to drop it totally, one or more embodiments rate limit it. This approach is thus an option for things that cannot be dropped in their entirety and this approach can be implemented in the ASIC/FPGA. This approach can be used for protocols that are legitimate in a “trickle” but are not permissible in large volumes due to almost certainly being a DDoS attack. The table of FIG. 16 shows, in the first column, an action to be taken (in each case, rate limit the traffic at 1%); in the second column, the protocol of interest; in the third column, the source port(s) of interest; in the fourth column, the destination port(s) of interest; in the fifth and sixth columns, the source and destination IP addresses of interest; in the seventh column, whether applicable to IPv4, IPv6, or both; and in the last column, the justification for the rate limitation.

FIG. 17 is a flow chart of throttling logic implemented by an unmanaged and active SFP device according to exemplary embodiments; the process is essentially continuous. A new packet is obtained at 1701 and becomes the current packet, the header of which is inspected/examined at 1703. At the decision block 1705, a determination is made whether the indicated inappropriate/suspicious protocol, port, etc. from FIG. 16 is present in the header of the current packet. If the answer is “YES,” proceed to decision block 1706. If the answer is “NO,” the current packet is passed at 1707 and the next new packet is obtained at 1701. In decision block 1706, determine whether the volume of traffic from the inappropriate/suspicious protocol, port, etc. from FIG. 16 is too high; if so, the current packet is throttled (discarded) 1709 and the next new packet is obtained at 1701; else, the current packet is passed at 1707 and the next new packet is obtained at 1701.

Given the discussion thus far, it will be appreciated that, in general terms, an exemplary apparatus, according to an aspect of the invention, includes a network interface receiver 1304-1/1304-2 configured to receive a plurality of packets (e.g., ROSA in case of an optical input). Also included is an electronic circuit 1208-1/1208-2 statically configured in hardware to extract a header of each received packet, evaluate each extracted header based on an access control ruleset, and, based on the evaluation, pass a first portion of the received packets and discard a second portion of the received packets (e.g., using an ASIC/FPGA, without the use of software). The apparatus further includes a network interface transmitter 1312-1/1312-2 configured to transmit the first portion of the received packets (e.g., circuit that outputs the electrical signal, in case of electrical output).

In one or more embodiments, the electronic circuit carries out detection and mitigation functions as described herein.

One or more embodiments further include a housing (e.g., like the outer casing 1029) enclosing the network interface receiver, the electronic circuit, and the network interface transmitter. In one or more embodiments, the housing has a height of less than 10 mm, a width of less than 15 mm, and a length of less than 60 mm.

As noted, the electronic circuit can be, for example, an ASIC or an FPGA. In one or more embodiments, the rules are hard-coded into the electronic circuit in that the ASIC/FPGA is programmed to drop/throttle the ports/protocols.

As also noted, the apparatus can be configured, for example, as electrical-to-optical, optical-to-electrical, or electrical-to-electrical. In the electrical to optical case, the network interface receiver is an electrical network interface receiver (e.g., electrical connector, pre-amplifier) and the network interface transmitter is an optical network interface transmitter (e.g., post amplifier, transmit optical subassembly (TOSA), and optical connector). In the optical to electrical case, the network interface receiver is an optical network interface receiver (e.g., optical connector, receive optical subassembly (ROSA)/pre-amplifier) and the network interface transmitter is an electrical network interface transmitter (e.g., post amplifier, electrical connector). In the electrical to electrical case, the network interface receiver is an electrical network interface receiver (e.g., electrical connector, pre-amplifier) and the network interface transmitter is an electrical transmitter (e.g., post-amplifier, electrical connector).

One or more embodiments are electrical on the network equipment side 1104 and can be electrical or optical on the network-facing side.

As noted, in one or more embodiments, the apparatus is bi-directional. Thus, in some instances, the network interface receiver is a network-facing network interface receiver 1212 configured to receive the plurality of packets from a network (e.g., upper arrow at right side of FIG. 12) and the network interface transmitter is a protected device-facing network interface transmitter configured to transmit the first portion of the received packets to a protected device (e.g., network equipment 1104). In this aspect, the apparatus further includes a protected-device facing network interface receiver (e.g., lower arrow at left-hand side of FIG. 12) configured to receive a plurality of packets from the protected device; and a network-facing network interface transmitter 1216. The electronic circuit 1208 is further configured in hardware to extract a header of each packet received from the protected device, evaluate each extracted header based on the access control ruleset, and, based on the evaluation, pass a first portion of the packets received from the protected device and discard a second portion of the packets received from the protected device; and the network-facing network interface transmitter 1216 is configured to transmit the first portion of the of the packets received from the protected device.

In addition to the techniques discussed with respect to FIGS. 14 and 15, in some instances, the electronic circuit 1208 is further statically configured in hardware to take account of a volume of packets of a predetermined type in the evaluation, as per FIGS. 16 and 17. Further, both techniques can be done together.

Advantageously, one or more embodiments are modular and can be plugged into many different devices and/or many modules can be plugged into different interfaces on one device.

In another aspect, an assembly is provided for connection to an upstream network. The assembly includes a small form-factor pluggable module as described, and a protected device such as 1104 coupled to the network interface transmitter.

In some cases, the network interface receiver includes an electrical network interface receiver; the network interface transmitter includes an electrical network interface transmitter; the network interface receiver is coupled to the upstream network with an electrical connector; and the network interface transmitter is coupled to the protected device with an electrical connector.

In some cases, the network interface receiver includes an optical network interface receiver; the network interface transmitter includes an electrical network interface transmitter; the network interface receiver is coupled to the upstream network with an optical connector; and the network interface transmitter is coupled to the protected device with an electrical connector.

As noted, modules can be bi-directional, such that the network interface receiver includes a network-facing network interface receiver configured to receive the plurality of packets from the upstream network and the network interface transmitter includes a protected device-facing network interface transmitter configured to transmit the first portion of the received packets to the protected device. In such instances, the small form-factor pluggable module further includes: a protected-device facing network interface receiver configured to receive a plurality of packets from the protected device and a network-facing network interface transmitter. Furthermore, the electronic circuit is further configured in hardware to extract a header of each packet received from the protected device, evaluate each extracted header based on the access control ruleset, and, based on the evaluation, pass a first portion of the packets received from the protected device and discard a second portion of the packets received from the protected device; and the network-facing network interface transmitter is configured to transmit the first portion of the of the packets received from the protected device.

In still another aspect, a trusted network is provided for connection to an upstream untrusted network. The trusted network includes a plurality of small form-factor pluggable modules as described, and a plurality of protected devices, within the trusted network, and coupled to the network interface transmitters of the plurality of small form-factor pluggable modules. The small form-factor pluggable modules can be bi-directional, as discussed elsewhere.

For example, at least one of the plurality of connected devices includes a router and at least another one of the plurality of connected devices includes a customer premises equipment (CPE) unit. Refer, for example, to the above discussion indicating that the SFP 1100 may be deployed in a variety of locations within a network or at a network boundary.

In an even further aspect, an exemplary method includes: attaching, between a unit of network equipment and an upstream interface towards an untrusted network, a small form factor pluggable device as discussed; receiving the plurality of packets from the untrusted network; and, with the electronic circuit, passing the first portion of the received packets and discarding the second portion of the received packets.

In some cases, the receiving step is carried out at no more than 10 Gbps.

In some instances, the receiving is carried out using an optical connector and the passing is carried out using an electrical connector.

In some instances, the receiving is carried out using an electrical connector and the passing is carried out using an electrical connector.

### System and Article of Manufacture Details

As noted, one or more embodiments of the invention or elements thereof can be implemented in hardware, such as with an ASIC or FPGA. As also noted, embodiments of the invention can be used, for example, in a network which makes use of (i) one or more non-transitory machine-readable medium(s) that contains one or more programs which when executed implement appropriate functionality; and/or (ii) one or more apparatus(es) including a memory and at least one processor that is coupled to the memory and operative to perform, or facilitate performance of, appropriate functionality (or a system wherein one or more such apparatuses are networked together, optionally with one or more other components). Software includes but is not limited to firmware, resident software, microcode, etc. An article of manufacture can include a machine-readable medium that contains one or more programs which when executed implement functionality; that is to say, a computer program product including a tangible computer readable recordable storage medium (or multiple such media) with computer usable program code configured to implement the functionality, when run on one or more processors.

Yet further, in another aspect, one or more embodiments of the invention or elements thereof can be used, for example, in a network which makes use of means for carrying out appropriate functionality; the means can include (i) specialized hardware module(s), (ii) software module(s) executing on one or more general purpose or specialized hardware processors, or (iii) a combination of (i) and (ii); the software modules are stored in a tangible computer-readable recordable storage medium (or multiple such media). Appropriate interconnections via bus, network, and the like can also be included. Again, this refers to aspects of a network in which embodiments of the invention can be employed; the embodiments themselves can be implemented in hardware as discussed herein.

As is known in the art, an article of manufacture used in the aforementioned network itself includes a tangible computer readable recordable storage medium having computer readable code means embodied thereon. The computer readable program code means is operable, in conjunction with a computer system, to implement appropriate functionality. A computer readable medium may, in general, be a recordable medium (e.g., floppy disks, hard drives, compact disks, EEPROMs, or memory cards) or may be a transmission medium (e.g., a network including fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). As used herein, a tangible computer-readable recordable storage medium is defined to encompass a recordable medium, examples of which are set forth above, but is defined not to encompass transmission media per se or disembodied signals per se. Appropriate interconnections via bus, network, and the like can also be included.

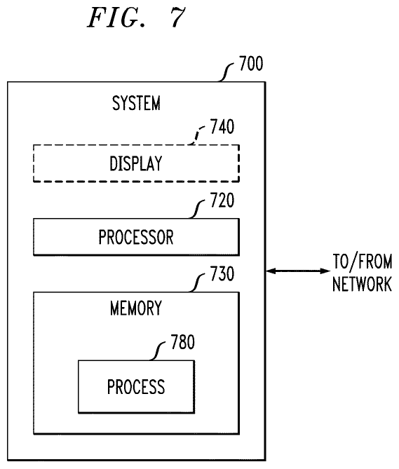

FIG. 7 is a block diagram of at least a portion of an exemplary system 700 that can be configured to implement at least some aspects of a network in which embodiments of the invention can be employed, and is representative, for example, of one or more of the apparatuses, servers, or modules shown in the figures. As shown in FIG. 7, memory 730 configures the processor 720 to implement one or more methods, steps, and functions (collectively, shown as process 780 in FIG. 7). The memory 730 could be distributed or local and the processor 720 could be distributed or singular. Different steps could be carried out by different processors, either concurrently (i.e., in parallel) or sequentially (i.e., in series).

The memory 730 could be implemented as an electrical, magnetic or optical memory, or any combination of these or other types of storage devices. It should be noted that if distributed processors are employed, each distributed processor that makes up processor 720 generally contains its own addressable memory space. It should also be noted that some or all of computer system 700 can be incorporated into an application-specific or general-use integrated circuit. For example, one or more method steps could be implemented in hardware in an ASIC or FPGA rather than using firmware. Again, this refers to aspects of a network in which embodiments of the invention can be employed; the embodiments themselves can be implemented in hardware as discussed herein. Display 740 is representative of a variety of possible input/output devices (e.g., keyboards, mice, and the like). Every processor may not have a display, keyboard, mouse or the like associated with it.

The computer systems and servers and other pertinent elements described herein each typically contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

As used herein, including the claims, unless it is unambiguously apparent from the context that only server software is being referred to, a “server” includes a physical data processing system running a server program. It will be understood that such a physical server may or may not include a display, keyboard, or other input/output components. Furthermore, as used herein, including the claims, a “router” includes a networking device with both software and hardware tailored to the tasks of routing and forwarding information. Note that servers and routers can be virtualized instead of being physical devices (although there is still underlying hardware in the case of virtualization).

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. An apparatus comprising:
a network interface receiver configured to receive a plurality of packets;
an electronic circuit statically configured in hardware to extract a header of each received packet, evaluate each extracted header based on an access control ruleset, and, based on the evaluation, pass a first portion of the received packets and discard a second portion of the received packets; and
a network interface transmitter configured to transmit the first portion of the received packets.

2. The apparatus of claim 1, further comprising a housing enclosing the network interface receiver, the electronic circuit, and the network interface transmitter, wherein the housing has a height of less than 10 mm, a width of less than 15 mm, and a length of less than 60 mm.

3. The apparatus of claim 2, wherein the electronic circuit comprises an application-specific integrated circuit.

4. The apparatus of claim 2, wherein the electronic circuit comprises a field-programmable gate array.

5. The apparatus of claim 2, wherein the network interface receiver comprises an electrical network interface receiver and the network interface transmitter comprises an optical network interface transmitter.

6. The apparatus of claim 2, wherein the network interface receiver comprises an optical network interface receiver and the network interface transmitter comprises an electrical network interface transmitter.

7. The apparatus of claim 2, wherein the network interface receiver comprises an electrical network interface receiver and the network interface transmitter comprises an electrical transmitter.

8. The apparatus of claim 2, wherein the network interface receiver comprises a network-facing network interface receiver configured to receive the plurality of packets from a network and the network interface transmitter comprises a protected device-facing network interface transmitter configured to transmit the first portion of the received packets to a protected device; further comprising:
a protected-device facing network interface receiver configured to receive a plurality of packets from the protected device; and
a network-facing network interface transmitter;
wherein:
the electronic circuit is further configured in hardware to extract a header of each packet received from the protected device, evaluate each extracted header based on the access control ruleset, and, based on the evaluation, pass a first portion of the packets received from the protected device and discard a second portion of the packets received from the protected device; and
the network-facing network interface transmitter is configured to transmit the first portion of the of the packets received from the protected device.

9. The apparatus of claim 2, wherein the electronic circuit is further statically configured in hardware to take account of a volume of packets of a predetermined type in the evaluation.

10. An assembly for connection to an upstream network, the assembly comprising:
a small form-factor pluggable module comprising:
a network interface receiver configured to receive a plurality of packets from the upstream network;
an electronic circuit statically configured in hardware to extract a header of each received packet, evaluate each extracted header based on an access control ruleset, and, based on the evaluation, pass a first portion of the received packets and discard a second portion of the received packets; and
a network interface transmitter configured to transmit the first portion of the received packets; and
a protected device coupled to the network interface transmitter.

11. The assembly of claim 10, wherein the small form-factor pluggable module further comprises a housing enclosing the network interface receiver, the electronic circuit, and the network interface transmitter, wherein the housing has a height of less than 10 mm, a width of less than 15 mm, and a length of less than 60 mm.

12. The assembly of claim 11, wherein the electronic circuit comprises an application-specific integrated circuit.

13. The assembly of claim 11, wherein the electronic circuit comprises a field-programmable gate array.

14. The assembly of claim 11, wherein:
the network interface receiver comprises an electrical network interface receiver;
the network interface transmitter comprises an electrical network interface transmitter;
the network interface receiver is coupled to the upstream network with an electrical connector; and
the network interface transmitter is coupled to the protected device with an electrical connector.

15. The assembly of claim 11, wherein:
the network interface receiver comprises an optical network interface receiver;
the network interface transmitter comprises an electrical network interface transmitter;
the network interface receiver is coupled to the upstream network with an optical connector; and
the network interface transmitter is coupled to the protected device with an electrical connector.

16. The assembly of claim 11, wherein the network interface receiver comprises a network-facing network interface receiver configured to receive the plurality of packets from the upstream network and the network interface transmitter comprises a protected device-facing network interface transmitter configured to transmit the first portion of the received packets to the protected device; wherein the small form-factor pluggable module further comprises:
a protected-device facing network interface receiver configured to receive a plurality of packets from the protected device; and
a network-facing network interface transmitter;
wherein:
the electronic circuit is further configured in hardware to extract a header of each packet received from the protected device, evaluate each extracted header based on the access control ruleset, and, based on the evaluation, pass a first portion of the packets received from the protected device and discard a second portion of the packets received from the protected device; and
the network-facing network interface transmitter is configured to transmit the first portion of the of the packets received from the protected device.

17. The assembly of claim 11, wherein the electronic circuit is further statically configured in hardware to take account of a volume of packets of a predetermined type in the evaluation.

18. A trusted network for connection to an upstream untrusted network, the trusted network comprising:
a plurality of small form-factor pluggable modules comprising:
a network interface receiver configured to receive a plurality of packets from the upstream network;
an electronic circuit statically configured in hardware to extract a header of each received packet, evaluate each extracted header based on an access control ruleset, and, based on the evaluation, pass a first portion of the received packets and discard a second portion of the received packets; and
a network interface transmitter configured to transmit the first portion of the received packets; and
a plurality of protected devices, within the trusted network, and coupled to the network interface transmitters of the plurality of small form-factor pluggable modules.

19. The trusted network of claim 18, wherein at least one of the plurality of connected devices comprises a router and at least another one of the plurality of connected devices comprises a customer premises equipment (CPE) unit.

20. A method comprising:
attaching, between a unit of network equipment and an upstream interface towards an untrusted network, a small form factor pluggable device including:
a network interface receiver configured to receive a plurality of packets;
an electronic circuit statically configured in hardware to extract a header of each received packet, evaluate each extracted header based on an access control ruleset, and, based on the evaluation, pass a first portion of the received packets and discard a second portion of the received packets; and
a network interface transmitter configured to transmit the first portion of the received packets;
receiving the plurality of packets from the untrusted network;
with the electronic circuit, passing the first portion of the received packets and discarding the second portion of the received packets.

21. The method of claim 20, wherein the receiving step is carried out at no more than 10 Gbps.

22. The method of claim 20, wherein the receiving is carried out using an optical connector and the passing is carried out using an electrical connector.

23. The method of claim 20, wherein the receiving is carried out using an electrical connector and the passing is carried out using an electrical connector.
